(19) United States
(12) Patent Application Publication
(10) Pub. No.: US 2025/0222866 A1
(43) Pub. Date: Jul. 10, 2025

(54) SUPPORT FOR A REAR-VIEW MIRROR AND METHOD FOR MOUNTING A SUPPORT FOR A REAR-VIEW MIRROR

(71) Applicant: FERRARI S.P.A., Modena (MO) (IT)

(72) Inventors: Gian Luca NAGLIATI, Modena (MO) (IT); Roberto GUANDALINI, Modena (MO) (IT)

(73) Assignee: FERRARI S.P.A., Modena (MO) (IR)

(21) Appl. No.: 19/014,670

(22) Filed: Jan. 9, 2025

(30) Foreign Application Priority Data
Jan. 10, 2024 (IT) 102024000000357

(51) Int. Cl. B60R 1/06

(52) U.S. Cl. CPC B60R 1/06

(57) ABSTRACT

A support for a rear-view mirror of a motor vehicle is described, comprising a first coupling surface and first fixing devices adapted to fix the first coupling surface to a fixing region of the motor vehicle. The support further comprises a second coupling surface and second fixing devices adapted to fix the second coupling surface to the rear-view mirror. The second coupling surface is angled relative to the first coupling surface.

### CROSS-REFERENCE TO RELATED APPLICATION

This patent application claims priority from Italian patent application no. 102024000000357 filed on Jan. 10, 2024, the entire disclosure of which is incorporated herein by reference.

### TECHNICAL FIELD

The present invention relates to a support for a rear-view mirror and to a method for mounting a support for a rear-view mirror.

### BACKGROUND

Motor vehicles are known comprising:
a frame;
a plurality of wheels rotatable relative to the frame about respective rotation axes;
a cabin integral with the frame and adapted to accommodate a driver and possible passengers; and
one or more rear-view mirrors arranged on the outside of the cabin.

It is possible to associate such motor vehicles with a Cartesian reference system comprising:
a first axis of longitudinal extension;
a second axis, which is perpendicular to the first axis and is vertical relative to the ground on which the wheels rest; and
a third axis, which is perpendicular to the first and the second axes.

In a known manner, each rear-view mirror essentially comprises a main body adapted to be operatively connected to a portion of the motor vehicle, for example an upright of a door, and a mirror supported by the main body.

Once each rear-view mirror has been mounted on the motor vehicle, each rear-view mirror extends transversal to the first axis of the motor vehicle and projects facing away from the cabin. Therefore, each rear-view mirror contributes to defining the total width of the motor vehicle, i.e. its extension parallel to the third axis.

Motor vehicles are further known comprising at least one rear-view mirror-generally two-rotatable relative to the frame between:
an extended position, in which the angle formed between the rear-view mirror and the first axis is greater than the angle formed between the rear-view mirror and the third axis; and
a retracted position, in which the angle formed between the rear-view mirror and the first axis is smaller than the angle formed between the rear-view mirror and the third axis.

Recently, in at least some vehicle segments, the automotive design has preferred cars characterized by increasingly smaller height/width ratios and—for the purpose of preserving the habitability of the cabins—increasingly greater widths. This trend has determined important complications for the transport of the motor vehicles, in particular between different continents, which is carried out especially by ship and inside containers.

In fact, it has been observed that the widths of some motor vehicles are not compatible with the dimensions of the containers, which are generally standardized. Specifically, some motor vehicles may not be loaded on board such containers even when one or both the rear-view mirrors are arranged in the retracted position.

In order to obviate such drawbacks, it has sometimes been resorted to the air transport of the motor vehicles or to the design and manufacturing of custom-made containers. Both such solutions, however, are very expensive and poorly sustainable from the environmental point of view.

On the other hand, it is necessary to observe that the minimum dimensions of the rear-view mirrors are generally defined by regulations and by certification authorities, for the purpose of ensuring compliance with high safety conditions. Therefore, the problem of the loading of the motor vehicles on board the standard containers may not be exclusively solved by reducing the dimensions of the rear-view mirrors.

It is further important to observe that the complete demounting of the rear-view mirrors prior to the insertion of the motor vehicle in the container is disadvantageous, because the functional and structural validations normally performed on the car could become ineffective following the demounting.

This is true especially when the rear-view mirrors comprise one or more electric or electronic devices electrically connected to a source of electrical energy of the motor vehicle. In fact, if a rear-view mirror is demounted after its electric functionality has been checked and certified, such electric functionality will have to be assessed again through further validation operations after the remounting of the rear-view mirror, for example, once the motor vehicle has reached the destination.

In light of the drawbacks described above, the need is felt to facilitate the transport of the motor vehicles.

An object of the invention is to satisfy the need set forth above, preferably in a simple and cost-effective manner.

### DESCRIPTION OF THE INVENTION

In one form, the invention can be a support for a rear-view mirror of a motor vehicle, the support comprising a first coupling surface, first fixing devices adapted to fix the first coupling surface to a fixing region of the motor vehicle, a second coupling surface, and second fixing devices adapted to fix the second coupling surface to the rear-view mirror, wherein the second coupling surface is angled relative to the first coupling surface.

In one form, the invention can be a rear-view mirror assembly for a motor vehicle, the rear-view mirror assembly comprising a rear-view mirror and a support according to the preceding paragraph, the rear-view mirror comprising a fixing portion adapted to be fixed to a region of the motor vehicle or to the support, the support being adapted to be fixed to the region of the motor vehicle.

In one form, the invention can be a motor vehicle comprising a frame, a cabin integral with the frame and adapted to accommodate at least a driver of the motor vehicle, and a rear-view mirror assembly according to the preceding paragraph.

In one form, the invention can be a method for mounting a support for a motor vehicle comprising the steps of i) providing a motor vehicle comprising a fixing region and at least one said rear-view mirror fixed to the fixing region, ii) removing said at least one rear-view mirror from the fixing region, iii) fixing a first surface of a support to the fixing region by means of first fixing devices, and iv) fixing said at least one rear-view mirror to a second surface of the support by means of second fixing devices, the second surface being angled relative to the first surface.

In one form, the invention can be a method for mounting a support for a motor vehicle comprising the steps of providing a motor vehicle comprising a fixing region and a rear-view mirror fixed to the fixing region, removing the rear-view mirror from the fixing region, fixing a first surface of a support to the fixing region by means of first fixing devices, and fixing the rear-view mirror to a second surface of the support by means of second fixing devices, the second surface being angled relative to the first surface.

### BRIEF DESCRIPTION OF THE DRAWINGS

In the following, an embodiment of the invention is described for a better understanding thereof, by way of non-limiting example and with reference to the accompanying drawings, wherein:

FIG. 1 is a perspective view of a support for a rear-view mirror according to the present invention;

FIG. 2 is a front view of a motor vehicle in a first step of a method for mounting the support of FIG. 1;

FIG. 3 is a perspective view on an enlarged scale of a portion of the motor vehicle of FIG. 2 in a second step of the method for mounting the support;

FIG. 4 is a perspective view on an enlarged scale of a portion of the motor vehicle of FIG. 2 in a third step of the method for mounting the support; and

FIG. 5 is a front view of the motor vehicle of FIG. 2 in a fourth step of mounting the support.

### DETAILED DESCRIPTION OF THE INVENTION

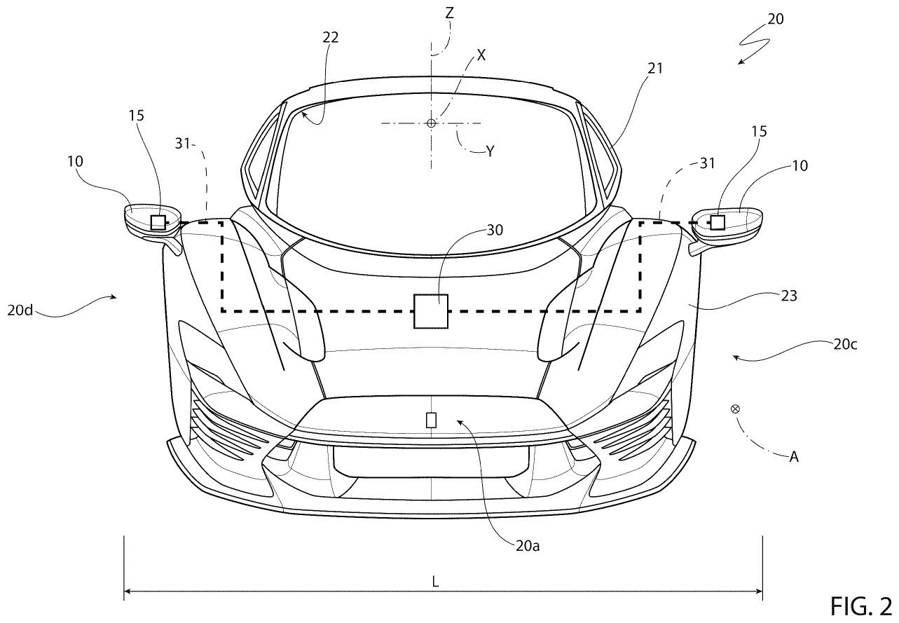

In FIG. 2, reference numeral 20 is used to indicate, as a whole, a motor vehicle in a configuration suitable for and/or compatible with the travel and comprising:
a frame 21;
a plurality of wheels-not illustrated-rotatable relative to the frame 21 about respective rotation axes; and
a cabin 22 integral with the frame 21 and adapted to accommodate a driver and possible passengers.

The motor vehicle 20 also comprises an external covering 23 or bodywork, which is fixed to the frame 21 and covers it.

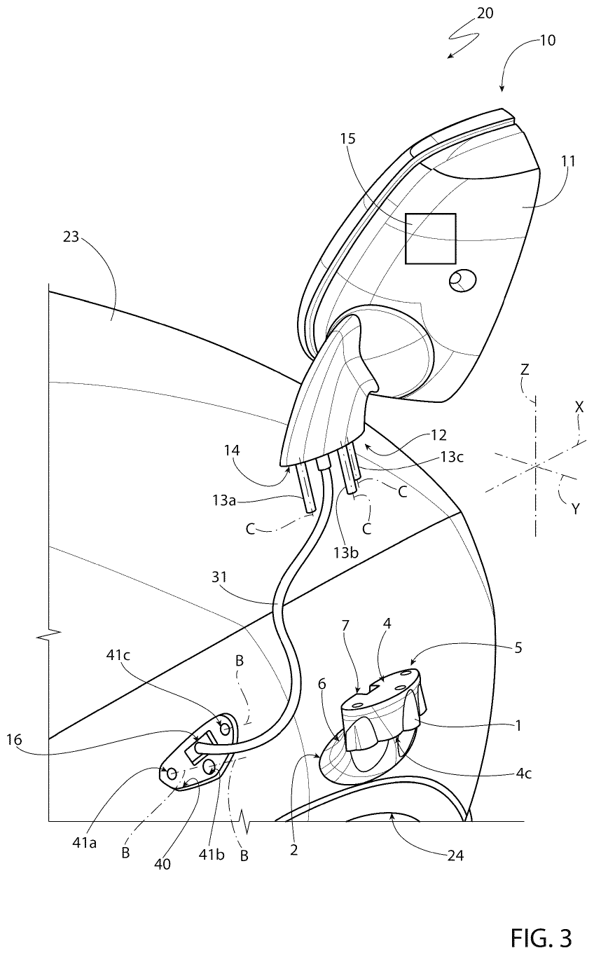

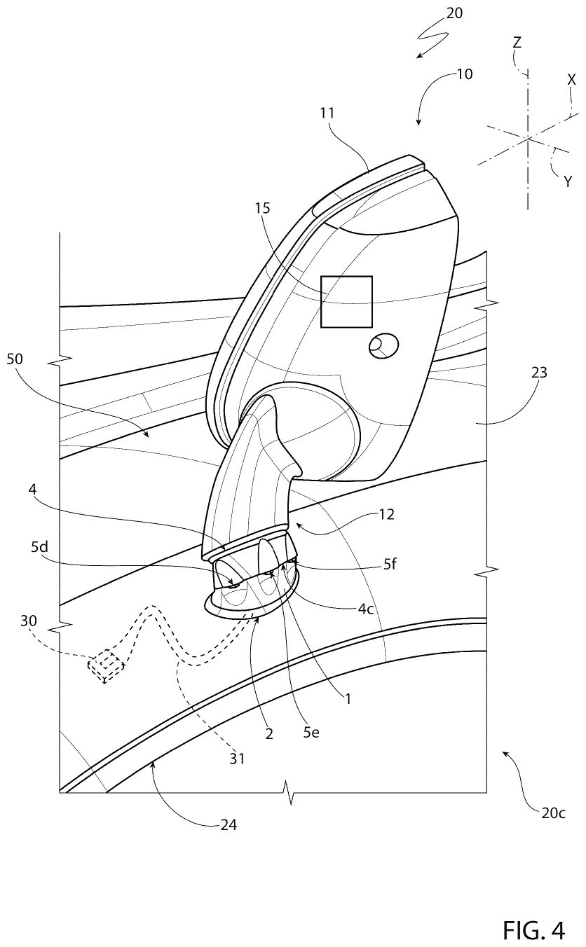

The external covering 23 comprises, in turn, four wheel compartments 24, one of which is partially illustrated in FIGS. 3 and 4. Each wheel compartment 24—in a known manner—is adapted to at least partially house a respective wheel of the motor vehicle 20.

In particular, and without thereby implying any loss of generality, the motor vehicle 20 is a sports car.

It is possible to associate the motor vehicle 20 with an integral reference system comprising:
an axis X of longitudinal extension;
an axis Z, which is vertical, in use, relative to the ground on which the wheels rest, and perpendicular to the axis X; and
an axis Y, which is perpendicular to the axes X and Z.

In addition, the motor vehicle 20 comprises a front end 20a and a rear end relative to a forward direction A of the motor vehicle 20. In detail, the end 20a and the rear end are arranged opposed to each other parallel to the axis X.

Still with reference to the forward direction A, the motor vehicle 20 comprises a left side portion 20c and a right side portion 20d. The left side portion 20c and the right side portion 20d are arranged opposed to each other parallel to the axis Y.

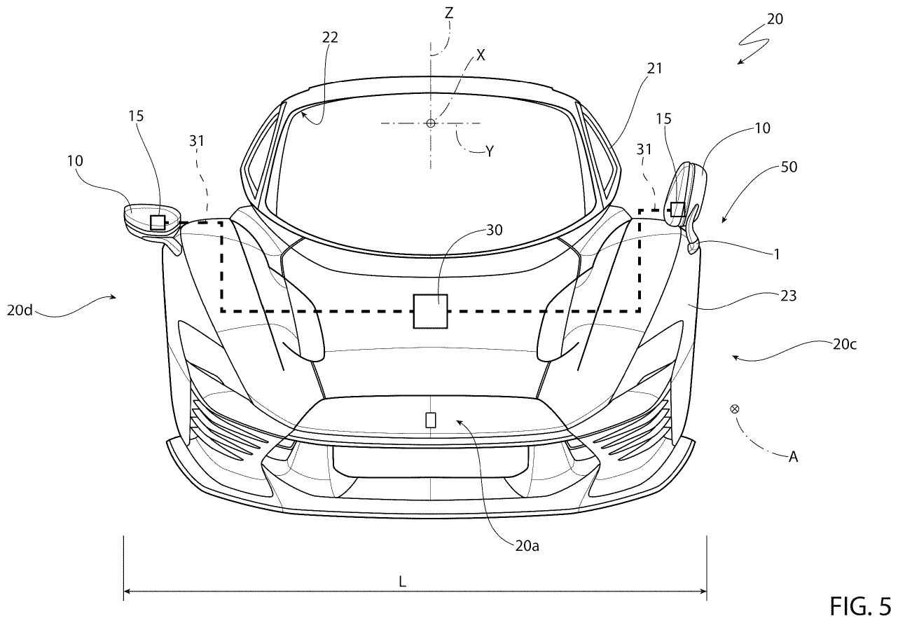

The motor vehicle 20 also comprises a source 30 of electrical energy, which is only schematically illustrated in FIGS. 2 and 5.

The motor vehicle 20 further comprises two rear-view mirrors 10, one of which is arranged at the left side portion 20c and the other one is arranged at the right side portion 20d and outside the cabin 22 (FIG. 2). In detail, in the configuration suitable for the travel illustrated in FIG. 2, the rear-view mirrors 10 are directly connected to the remaining part of the motor vehicle 20, i.e. without the interposition of further elements between the rear-view mirrors 10 and the remaining part of the motor vehicle 20.

When the motor vehicle 20 is in the configuration suitable for the travel, both rear-view mirrors 10 extend transversal to the axis X and perpendicular or substantially perpendicular to the axis Z. In addition, each rear-view mirror 10 projects relative to the external covering 23 along the axis Y facing away from the cabin 22.

Still considering the motor vehicle 20 in the configuration suitable for the travel illustrated in FIG. 2, the rear-view mirrors 10 define respective ends of the motor vehicle 20 parallel to the axis Y. Therefore, in such configuration, the overall width L of the motor vehicle 20, i.e. its bulk parallel to the axis Y, coincides with the distance of the respective ends of the rear-view mirrors 10 arranged opposed to the cabin 22 (FIG. 2).

Preferably, each rear-view mirror 10 is rotatable relative to the frame 21 between:
an extended position, in which the angle formed between the rear-view mirror 10 and the axis X is greater than the angle formed between the rear-view mirror 10 and the axis Y; and
a retracted position, in which the angle formed between the rear-view mirror 10 and the axis X is smaller than the angle formed between the rear-view mirror 10 and the axis Y.

In particular, the overall width L of the motor vehicle 20 is greater when the rear-view mirrors 10 are in the respective extended positions relative to when the rear-view mirrors are in the respective retracted positions.

The motor vehicle 20 further comprises two regions 40 (only one of which is illustrated in FIG. 3), at each of which a respective rear-view mirror 10 is adapted to be fixed. In the illustrated embodiment, the regions 40 are arranged at the external covering 23, in particular at the front relative to the cabin 22. Preferably, each region 40 is recessed relative to the outermost surface of the external covering 23. In addition, each region 40 is aligned with a respective wheel compartment 24 parallel to the axis X (FIGS. 3 and 4).

The motor vehicle 20 comprises three holes 41a, 41b, 41c at each region 40. The three holes 41a, 41b, 41c extend along respective axes B which are transversal to the axis X and parallel to one another.

The holes 41a, 41b, 41c pass through the external covering 23 from the region 40 to the respective wheel compartment 24.

In detail, the holes 41a, 41b and 41c are each arranged at a respective vertex of a triangle. In further detail, the distance of the hole 41a and the hole 41b is equal to the distance of the hole 41b and the hole 41c.

For the sake of brevity, in the following of the present description, reference will be made to only one rear-view mirror 10, since the description of one of the two rear-view mirrors 10 is identical also for the other one of the two.

The rear-view mirror 10 comprises:
a main body 11;
a mirror-not illustrated-supported by the main body 11; and
a fixing portion 12 at which the rear-view mirror 10 is adapted to be connected at least indirectly to the region 40.

Preferably, the mirror 10 is movable relative to the main body 11. Therefore, the position of the mirror relative to the main body 11 can be adjusted, so as to vary the visual field of the driver of the motor vehicle 20 inside the cabin 22.

The rear-view mirror 10 comprises three fixing pins 13a, 13b, 13c at the fixing portion 12, each adapted to engage a respective hole 41a, 41b, 41c (FIG. 3).

In detail, the fixing portion 12 comprises a coupling surface 14 and the three fixing pins 13a, 13b, 13c project from the coupling surface 14. In the illustrated embodiment, the coupling surface 14 is flat or substantially flat and is adapted to come into contact with the region 40 and the three pins 13a, 13b, 13c extend along respective axes C which are perpendicular to the coupling surface 14 and parallel to one another.

In further detail, the pins 13a, 13b, 13c are each arranged at a respective vertex of a triangle. In addition, the distance of the pin 13a and the pin 13b is equal to the distance of the pin 13b and the pin 13c.

In addition, the holes 41a, 41b, 41c are preferably arranged at relative distances between one another corresponding to the relative distances between the pins 13a, 13b, 13c.

The rear-view mirror 10 also comprises one or more electric and/or electronic devices 15—only schematically illustrated—adapted to be electrically connected to the source 30 of electrical energy. By way of example, the devices 15 comprise means for varying the position of the mirror relative to the main body 11, means for adjusting the position of the rear-view mirror 10 relative to the frame 21 and/or lighting devices.

In detail, the electric and/or electronic devices 15 are electrically connected to the source 30 by means of an electric cable 31 of the motor vehicle 20.

In further detail, the motor vehicle 20 comprises an opening 16 at the region 40, through which the electric cable 31 passes. In the illustrated embodiment, the opening 16 is interposed between the holes 41a and 41c along a direction passing through the holes 41a and 41c (FIG. 3).

FIG. 5 illustrates the motor vehicle 20 in a configuration suitable for the transport, in particular for the dispatch from a departure place to an arrival place.

Advantageously, the motor vehicle 20, at least in the aforementioned configuration suitable for transport, comprises a support 1. The support 1 is adapted to be fixed to the remaining part of the motor vehicle 20 at the region 40 and to be fixed, in turn, to a rear-view mirror 10, so as to allow the connection thereof to the remaining part of the motor vehicle 20.

In other words, when the motor vehicle 20 is in the configuration suitable for the transport, one of the rear-view mirrors 10 is no longer directly fixed to the relative region 40, but is fixed to the remaining part of the motor vehicle 20 by means of the support 1.

The support 1 and the relative rear-view mirror 10 define a support assembly 50.

In the illustrated embodiment, the support 1 is adapted to support the rear-view mirror 10 arranged on the part of the left side portion 20c.

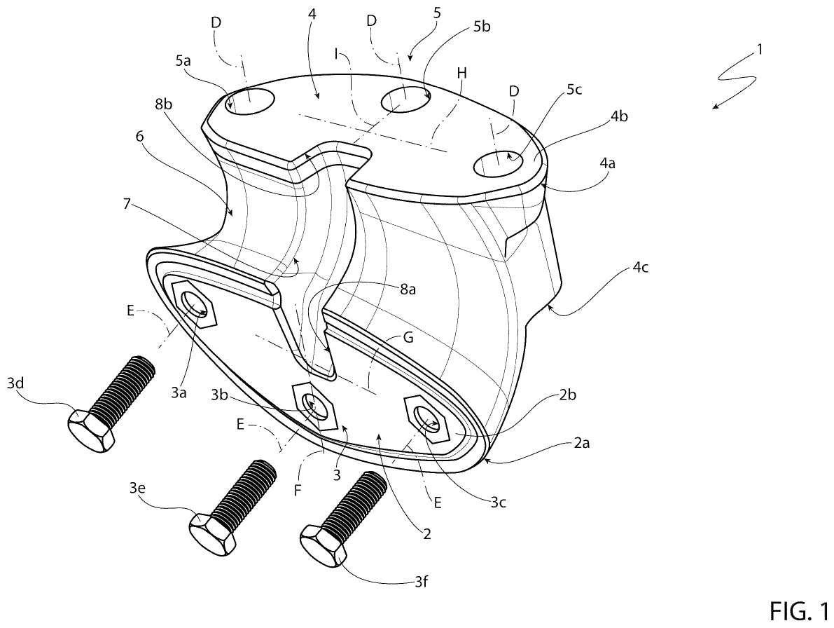

The support 1 comprises (FIG. 1):
a coupling surface 2;
fixing devices 3 adapted to fix the coupling surface 2 to the region 40;
a coupling surface 4 angled relative to the coupling surface 2; and
fixing devices 5 adapted to fix the coupling surface 4 to the relative rear-view mirror 10.

In light of the inclination between the coupling surfaces 2 and 4, the rear-view mirror 10 fixed to the support 1 extends parallel or substantially parallel to the axis Z. In other words, when the vehicle 20 is in the condition suitable for the transport, the rear-view mirror 10 is vertical to the ground (FIG. 5).

Therefore, the overall width L in such configuration suitable for the transport (FIG. 5) is smaller than the overall width L in the configuration suitable for the travel (FIG. 2).

The support 1 is made of a plastic material, of metal or a metal alloy.

In detail, the coupling surfaces 2 and 4 lie on respective planes transversal to each other and such planes form an angle between 85° and 95° with each other, preferably of 90°.

The coupling surfaces 2 and 4, in addition, are spaced apart and separate from each other (FIG. 1).

When the support 1 is fixed to the region 40, the coupling surface 4 faces the cabin 22 and/or faces away from the ground on which the motor vehicle 20 rests.

In the illustrated embodiment, considering a section plane orthogonal to the coupling surfaces 2 and 4, the support 1 has a C shape.

The support 1 further comprises a groove 7 adapted to house at least part of the electric cable 31. In other words, the groove 7 carries out the function of cable grommet.

The fixing devices 3 comprise three holes 3a, 3b, 3c at the coupling surface 2 and extending along respective axes E parallel to one another and transversal to the coupling surface 2. Preferably, the axes E are perpendicular to the coupling surface 2 (FIG. 1).

In detail, the holes 3a, 3b and 3c are each arranged at a respective vertex of a triangle. In further detail, the distance of the hole 3a and the hole 3b is equal to the distance of the hole 3b and the hole 3c.

The holes 3a, 3b, 3c are at least partially threaded. In the illustrated embodiment, each hole 3a, 3b, 3c comprises a respective threaded nut. In detail, such threaded nut is made by comoulding.

The fixing devices 3 further comprise three screws 3d, 3e and 3f. In detail, each screw 3d, 3e, 3f is adapted to engage a respective hole 41a, 41b, 41c on the part of the wheel compartment 24 and a respective hole 3a, 3b, 3c.

In addition, it is possible to associate the coupling surface 2 with an axis F and an axis G lying on the plane defined by the coupling surface 2 and orthogonal to each other. In detail, the axis G is directed according to the joining line of the holes 3a and 3c; the axis F passes through the hole 3b (FIG. 1).

The coupling surface 2 comprises a perimeter 2a and a region 2b delimited by the perimeter 2a. The coupling surface 2 further comprises an opening 8a at the perimeter 2a. In detail, the opening 8a has a U shape. In further detail, the opening 8a is aligned with the hole 3b along the axis F.

Preferably, the perimeter 2a has an elliptical or substantially elliptical shape. In addition, the axes F and G are directed according to the semiaxes of the elliptical shape.

In addition, the holes 3a, 3b, 3c are preferably arranged at relative distances with one another corresponding to the relative distances of the holes 41a, 41b, 41c.

The fixing devices 5 comprise three holes 5a, 5b, 5c at the coupling surface 4 and extending along respective axes D parallel to one another and transversal to the coupling surface 4. Preferably, the axes D are perpendicular to the coupling surface 4.

Specifically, the holes 5a, 5b and 5c are each arranged at a respective vertex of a triangle. In further detail, the distance of the hole 5a and the hole 5b is equal to the distance of the hole 5b and the hole 5c.

The holes 5a, 5b, 5c are adapted to be each engaged by a respective fixing pin 13a, 13b, 13c.

In addition, the support 1 comprises a surface 4c arranged opposed to the coupling surface 4 along the axes D. In detail, the holes 5a, 5b, 5c pass through from the coupling surface 4 to the surface 4c.

The fixing devices 5 further comprise three nuts 5d, 5e, 5f adapted to prevent the relative sliding of a respective fixing pin 13a, 13b, 13c and the relative hole 5a, 5b, 5c. In detail, each nut 5d, 5e, 5f engages a respective fixing pin 13a, 13b, 13c on the part of the surface 4c (FIG. 4).

In further detail, the surface 4c is arranged opposed to the groove 7 relative to the coupling surface 4 (FIG. 1).

In addition, it is possible to associate the coupling surface 4 with an axis H and an axis I lying on the plane defined by the coupling surface 4 and orthogonal to each other. In detail, the axis H is directed according to the joining line of the holes 5a and 5c; the axis I passes through the hole 5b.

The coupling surface 4 comprises a perimeter 4a and a region 4b delimited by the perimeter 4a. The coupling surface 4 further comprises an opening 8b at the perimeter 4a. In detail, the opening 8b has a U shape.

Preferably, the perimeter 4a has an elliptical or substantially elliptical shape. In addition, the axes H and I are directed according to the semiaxes of the elliptical shape.

The opening 8b is further aligned with the hole 5b along the axis I.

In addition, the holes 5a, 5b, 5c are preferably arranged at relative distances with one another corresponding to the relative distances of the pins 13a, 13b, 13c. The holes 5a, 5b, 5c are also preferably arranged at relative distances with one another corresponding to the relative distances of the holes 41a, 41b, 41c.

The support 1 also comprises a surface 6 extending between the coupling surface 2 and the coupling surface 4. The surface 6 is adapted to face the external covering 23.

The support 1 comprises the groove 7 at the surface 6. In detail, the groove 7 extends between the opening 8a and the opening 8b.

In the following, the mounting of the support 1 and of the assembly 10 is described starting from a condition in which the motor vehicle 20 is in the configuration suitable for the travel (FIG. 2). In such configuration, the rear-view mirrors 10 are both fixed to the remaining part of the motor vehicle 20 at the respective regions 40 and the devices 15 are electrically connected to the source 30 of electrical energy 30. Specifically, the pins 13a, 13b, 13c of each rear-view mirror 10 are housed in the respective holes 41a, 41b, 41c.

For the purpose of arranging the motor vehicle 20 in the configuration suitable for the transport, the pins 13a, 13b, 13c of one of the rear-view mirrors 10 are removed from the respective holes 41a, 41b, 41c, in particular after the unscrewing of three nuts (not illustrated) from the respective pins 13a, 13b, 13c. In addition, the rear-view mirror 10 is moved away from the relative region 40, keeping the electrical connection between the devices 15 and the source 30 of electrical energy (FIG. 3).

Subsequently, the support 1 is fixed to the region 40 by means of the fixing devices 3. In detail, each screw 3d, 3e, 3f is engaged at a respective hole 41a, 41b, 41c on the part of the wheel compartment 24 and is subsequently screwed to a respective hole 3a, 3b, 3c.

At the end of the fixing of the support 1 to the region 40, the coupling surface 4 faces the cabin 22 and/or faces away from the ground and the surface 6 faces the external covering 23.

The rear-view mirror 10 is thus fixed to the support 1 at the coupling surface 4. In detail, the pins 13a, 13b, 13c are each inserted in a corresponding hole 5a, 5b, 5c, up to coming out at the surface 4c. Subsequently, the nuts 13d, 13e and 13f are screwed (FIG. 4).

During the fixing of the rear-view mirror 10 to the support 1, the electric cable 30 is engaged in the groove 7.

Once the mounting has been completed, the rear-view mirror 10 is parallel or substantially parallel to the axis Z and the motor vehicle 20 is in the configuration suitable for the transport (FIG. 5).

Based on the foregoing, the advantages of the support 1, of the assembly 10, of the motor vehicle 20 and of the method for mounting according to the invention are evident.

In particular, since the support 1 comprises the coupling surfaces 2 and 4, which are angled relative to each other, and since such coupling surfaces 2 and 4 are respectively fixed to the region 40 and to a rear-view mirror 10, such rear-view mirror 10 can be mounted on the motor vehicle 20 so as to reduce the overall length L thereof. At the end of the mounting, the motor vehicle 20 is in the configuration suitable for the transport, wherein the transport of the motor vehicle 20 is facilitated. Specifically, since the overall length has been decreased L, the loading of the motor vehicle 20 in a container for the ship transport is eased.

Since the rear-view mirror 10 remains electrically connected to the source 30 of electrical energy also when it is physically decoupled from the region 40, it is not necessary to carry out further validation operations following the remounting of the rear-view mirror 10.

Since the support 1 comprises the groove 7, which acts as cable sleeve, the electric cable 31, which electrically connects the devices 15 to the source 30 of electrical energy is kept in position also when the motor vehicle 20 is in the configuration suitable for the transport. In this manner, the electrical connection between the rear-view mirror 10 and the source 30 of electrical energy can be kept in safety also during the mounting of the support 1 and following the mounting of the support 1.

Finally it is clear that modifications and variations can be made to the support 1, the assembly 10, the motor vehicle 20 and the method for mounting according to the invention which anyway do not depart from the scope of protection defined by the claims.

The rear-view mirror 10 could comprise a number of fixing pins 13a, 13b, 13c different from three, for example, two or more than three. Similarly, the region 40 could comprise a number of holes 41a, 41b, 41c different from three, for example, two or more than three.

The support 1 could be adapted to support the rear-view mirror 10 arranged on the part of the right side portion 20d.

Alternatively, the motor vehicle 20 could comprise two supports 1, adapted to support respective rear-view mirrors 10.

The fixing devices 3 could comprise a number of holes 3a, 3b, 3c different from three, for example, two or more than three. The fixing devices 5 could comprise a number of holes 5a, 5b, 5c different from three, for example, two or more than three.

One or more of the holes 3a, 3b, 3c, 5a, 5b, 5c, 41a, 41b, 41c could be a slot.

According to a variation not illustrated, the region 40 could comprise three pins instead of the holes 41a, 41b, 41c adapted to engage the holes 3a, 3b, 3c and the rear-view mirror 10 could comprise three holes instead of the pins 13a, 13b, 13c adapted to be respectively engaged by the three pins of the region 40. According to such variation, the fixing devices 5 could further comprise three pins instead of the holes 5a, 5b, 5c adapted to engage the three holes of the rear-view mirror 10.

The rear-view mirror 10 fixed to the support 1 may not be parallel to the axis Z, but may be angled relative to the axis Z, towards the other rear-view mirror 10.

1. A support for a rear-view mirror of a motor vehicle, the support comprising:
a first coupling surface;
first fixing devices adapted to fix said first coupling surface to a fixing region of said motor vehicle;
a second coupling surface; and
second fixing devices adapted to fix said second coupling surface to said rear-view mirror;
wherein said second coupling surface is angled relative to said first coupling surface.

2. The support according to claim 1, wherein said first coupling surface and said second coupling surface lie on respective planes that are transversal to each other.

3. The support according to claim 2, wherein said planes form an angle between 85° and 95° with each other.

4. The support according to claim 1, further comprising a third surface, which extends between said first surface and said second surface;
said support further comprising a groove at said third surface;
said groove being adapted to be engaged by an electric cable of said motor vehicle.

5. A rear-view mirror assembly for a motor vehicle, the rear-view mirror assembly comprising:
a rear-view mirror; and
a support according to claim 1;
said rear-view mirror comprising a fixing portion adapted to be fixed to a region of said motor vehicle or to said support;
said support being adapted to be fixed to said region of said motor vehicle.

6. The rear-view mirror assembly according to claim 5, wherein said rear-view mirror further comprises one or more electric and/or electronic devices adapted to be electrically connected to a source of electrical energy of said motor vehicle.

7. A motor vehicle, comprising:
a frame;
a cabin integral with said frame and adapted to accommodate at least a driver of said motor vehicle; and
a rear-view mirror assembly according to claim 5.

8. The motor vehicle according to claim 7, comprising a fixing region;
said first coupling surface being fixed to said fixing region;
said second coupling surface facing said cabin and/or being facing away from the ground on which said motor vehicle rests, in use.

9. The motor vehicle according to claim 7, wherein said fixing region comprises at least two first holes and said second fixing devices comprise at least two second holes at said second coupling surface;
wherein the relative distance of said first holes corresponds to the relative distance of said second holes;
said rear-view mirror comprising at least two pins adapted to respectively engage the two first holes or said second holes.

10. The motor vehicle according to claim 7, defining:
a first axis of longitudinal extension;
a second axis, which is vertical, in use; and
a third axis, which is perpendicular to said first axis and said second axis;
wherein the rear-view mirror of said rear-view mirror assembly when fixed to said support is parallel to said second axis.

11. The motor vehicle according to claim 7, defining:
a first axis of longitudinal extension;
a second axis, which is vertical, in use; and
a third axis, which is perpendicular to said first axis and said second axis;
wherein the rear-view mirror of said rear-view mirror assembly when fixed to said support is substantially parallel to said second axis.

12. A method for mounting a support for a motor vehicle comprising the steps of:
i) providing a motor vehicle comprising a fixing region and at least one rear-view mirror fixed to said fixing region;
ii) removing said rear-view mirror from said fixing region;
iii) fixing a first surface of a support to said fixing region by means of first fixing devices; and
iv) fixing said rear-view mirror to a second surface of said support by means of second fixing devices; said second surface being angled relative to said first surface.

13. The method for mounting according to claim 12, wherein at the end of said step iii), said second surface faces a cabin of said motor vehicle and/or faces away from the ground on which said motor vehicle rests.

14. The method for mounting according to claim 12, wherein said motor vehicle comprises a source of electrical energy and said rear-view mirror comprises at least one electric device; said electric device being electrically connected to said source by means of an electric cable during said step i);
said method comprising the further step v) of keeping said electric device electrically connected to said source during the steps ii), iii) and iv).

15. The method for mounting according to claim 14, wherein said step v) comprises the step vi) of inserting at least part of said electric cable into a groove of said support.

16. The method for mounting according to claim 12, wherein said motor vehicle comprises a source of electrical energy and said rear-view mirror comprises at least one electronic device; said electronic device being electrically connected to said source by means of an electric cable during said step i);
said method comprising the further step v) of keeping said electronic device electrically connected to said source during the steps ii), iii) and iv).

17. The method for mounting according to claim 16, wherein said step v) comprises the step vi) of inserting at least part of said electric cable into a groove of said support.
